(19) United States
(12) Patent Application Publication
(10) Pub. No.: US 2005/0272477 A1
(43) Pub. Date: Dec. 8, 2005

(54) Voice dependent recognition wireless headset universal remote control with telecommunication capabilities

(76) Inventors: Sakata Estina Boykins, Atlanta, GA (US); Dream Vicky Bailey, Atlanta, GA (US)

Correspondence Address: Sakata E. Boykins, P O B 78141, Atlanta, GA, 30357, US

(21) Appl. No.: 10/960,519

(22) Filed: Jun. 7, 2004

(51) Int. Cl. H04M 1/00

(52) U.S. Cl. 455/569.1; 455/563

(57) ABSTRACT

A Voice Dependent Recognition Wireless Headset Universal Remote Control with Telecommunication Capabilities has a headset that includes communication equipment and universal remote control equipment by way of voice recognition. The headset provides cordless telephone functionality, and the universal remote control equipment for remote control of plurality remotely controlled electronics. The headset includes a mode controller in communication with the communication equipment and the universal remote control equipment. The mode controller provides at least one convenience mode. When a convenience mode is active, the mode controller responds to detection of an incoming call by automatically limiting utilization of the communication equipment and/or one or more entertainment device, based on the active convenience mode.

### BACKGROUND

1. Field of the Invention

The present invention relates in general to cordless telephone and electronic equipment an universal remote control for entertainment devices. the present invention relates to a wireless headset that provides both telephone and universal remote control capabilities.

2. Description of Prior Art

This society has become dependent on convenience meaning you want to get up off the couch as little as possible for example cordless telephone a part of this era they are easy to keep nearby for use in answering incoming calls. For instance if a person is to sit on a couch and watch television that person might place a cordless telephone within arms reach if a call comes in, the call could be answered without getting up from the couch. The universal remote control is another type of personal convenience item that has attained widespread acceptance and utilization. If a person was to sit on a couch to watch television in addition to placing the cordless phone nearby, one might also place the universal remote control nearby. That way if a call were to come in, the remote control could be used to reduce the volume or channel surf the television. Patiently therefore, cordless telephone and universal remotes each provides certain benefits with regards to their respective field of application, the fields of personal and utilization of entertainment devices, respectively dissemination.

Therefore, today's cordless phone and today's universal remote control are typically limited to physical operation for example, if a person wants to change the channel on a television and reduce the volume on an entertainment device the user must locate the remote control and operate the device change or reduce volume button. however, as recognized by the present invention, physical operation is an incomfort to the user. A more convenience world would enjoy if the user had free control of certain entertainment devices. Moreover, a voice independent remote telecommunication equipment and universal remote control equipment would greatly improve convenience for the user. Since one of the primary objects of the cordless telephone and the universal remote control is to do as little as possible. Any increase in convenience would be powerful. To allow the user to move about and do more hand involve duties and be able to control the telephone plus any remotely control equipment would fit on the convenience level. The present invention recognizes that physical operation are inconvenience and that cordless telephone and universal remote controls could be substantially improved. The U.S. Pat. No. 5,963,624 issued to Steven M Pope discloses that remote controls functionality can be added to cordless telephone assembly including a handset and a base unit. Pope patent relates to a cordless telephone adapted for controlling entertainment devices via a base unit while the cordless telephone is being utilized in a room other than the room containing the entertainment devices and base unit. However the Pope patent does not teach involving speech recognition or automating any telephone or remote control features in headset form. Pope advise against automatically muting a compact disk player while the cordless telephone is being utilized in a different room.

U.S Pat. No. 5,128,987 issued to McDonough, U.S. Pat. No. 5,542,102 issued to Smith et al. and Korean Patent number 9,07064 Pope explains that the Korean patent relates to a handset that includes an infrared transmitter for muting television. None of the above patents, however, contain any suggestion to provide a device that can be customized by the user to change the way automated responses are made to changing conditions, where the conditions may relate to an entertainment device (such as when a channel is changed) or to many telephone communication equipment (such as when a call comes in) by way of a headset.

### OBJECTS AND ADVANTAGES

The voice dependent recognition system of the mode controller in communication with the telecommunication equipment and the remote control equipment provides a voice operated remote control intended to replace multiple entertainment systems remote with telecommunication capabilities. Voice dependent recognition wireless headset universal remote control with telecommunication capabilities in which an infrared signal transmitted from a transmitting apparatus is received and reproduced as an recognizable sound by a headphone unit portion this headset apparatus includes a body having a microphone at one end and a transducer at the opposite end, an earhook for attaching the apparatus to the ear of the user. The headset contains the apparatus to hook to the ear of the user. The headset contains a mechanism within the body in a movable engagement for holding the ear hook in a frictional engagement that allows for movement of the earhook the headset remains properly balanced and within the sound envelope of the user for uninterrupted use with in the body a first light receiving element is provided above the microphone insert slot so that when a user wears that headset, a light receiving surface included in the first receiving element is directed forward so that the third light receiving element are provided on the base unit. It preferably includes two parts a base unit and a headset unit. During operating the base unit receives each electronic driver signal. This signal is then subtracted form detected sound and a residual is used to detect spoken commands. in response to spoken commands, learned IR commands are transmitted by the headset to the device and base unit simultaneously and direct them toward the appropriate entertainment system.

1. A body having appositely disposed first and second and

2. A wireless headset having charging terminals for charging a secondary battery.

3. An apposition and balance point, interpolated microphone, transducer and the body is configured to sit comfortable on the users ear.

4. The telephone headset wherein the earhook holding means includes a circular clutch having a through going bore for retaining the earhook.

5. The telephone headset wherein the body includes two cooperating pieces one a recessed portion, the recessed portions defining well for movable retaining the earhook holding means.

6. The telephone headset where as the transducer includes a vertex for positioning within the ear of the user.

7. The telephone headset wherein the transducer is circular and has a center point.

A second aspect of the present invention in a wireless headset having a charging terminals for charging a secondary battery included with The headset. the headset unit preferably uses little power and relays a microphone signal to the base unit that represents user speech among other noise. the base unit is either in line with infrared signal, or is connected to receive a copy of those signals. The base unit thereby produces a residual used to recognize the user's spoken commands. Upon detect of a spoken command, infrared commands can then be transmitted to the remote unit, which can have an infrared repeater for relaying commands back to the appropriate entertainment and telephone systems. All objects features and advantages of the present invention will become apparent in the following detailed written description.

### DRAWING FIGURES

FIG. 1. Shows a user perspective view illustrating an embodiment of a wireless headset system according to the present invention.

FIG. 2. Shows an illustrating perspective view illustrating the base unit of a wireless headset system.

FIG. 3. Illustrates the backside movement of the earhook and also relates to earphone unit for hearing incoming calls, earhook swivel unit for adjustability of body positioning, body which includes voice recognition circuitry, microphone, and earhook swivel unit support;

FIG. 4. Illustrates microphone positioning from the front side view, body, earhook swivel unit is outlined, earhook unit and headset unit;

FIG. 5. Illustrates the circuitry of the headset unit, for receiving light receiving signals from the back end of head set unit, three LED units, speaker line, body, and microphone

FIG. 6. Illustrates the charging mode of the base unit, body, three LED units, outline headset in charging mode, earhook unit, body of headset, and microphone;

FIG. 7. Illustrates to view of headset unit, earhook unit and microphone.

### REFERENCE NUMERALS IN DRAWINGS

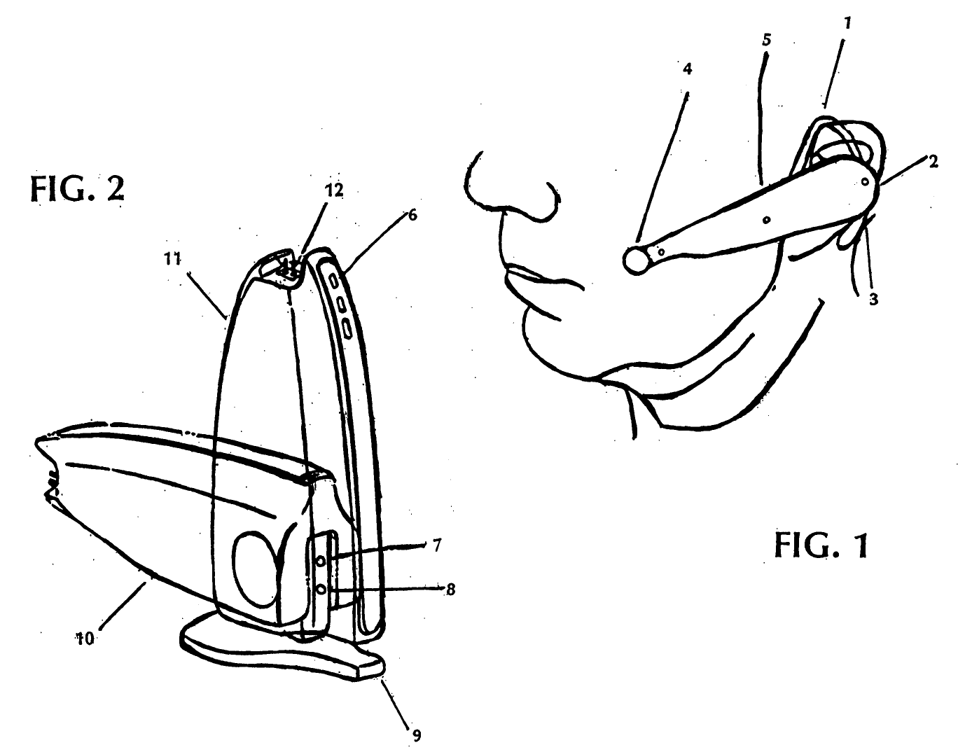

FIG. 1.
1. Earhook engagement
2. Headset unit portion
3. Earlobe supporter
4. Microphone
5. Body

FIG. 2.
6. RF receiving portion
7. Train button
8. Program button
9. Base (stand)
10. 11. Body
12. Armpit charger portion

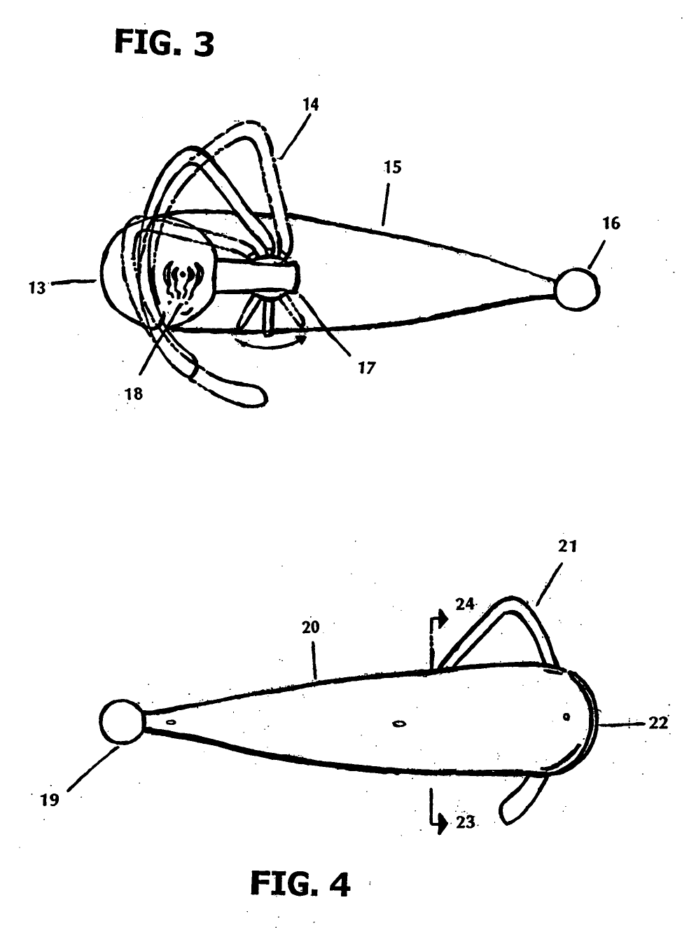

FIG. 3.
13. Speaker/battery portion
14. Earhook engagement swivel
15. Body
16. Microphone
17. Swivel support unit
18. Speaker

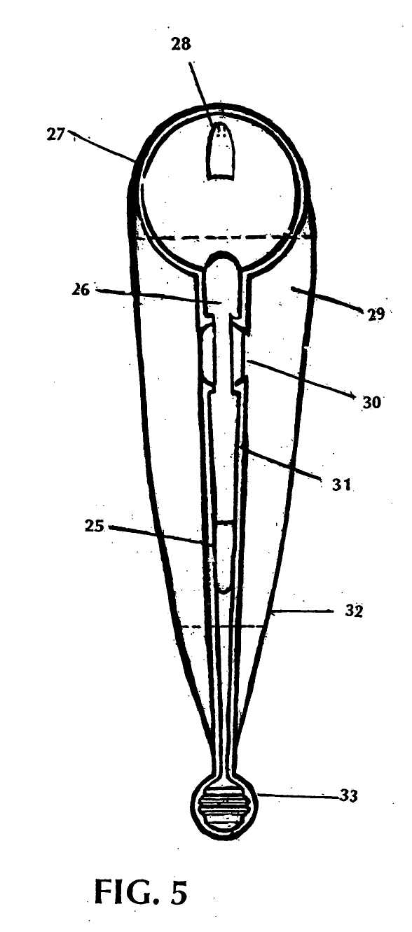

FIG. 4.
19. Microphone
20. Body
21. Earhook engagement
22. Headset unit portion
23. 24. Ear supporter

FIG. 5.
25. LED 1 lower end
26. LED 2 middle
27. Headset unit/battery/speaker
28. LED 3 top end
29. Circuit board
30. LED enclosure tube
31. LED connector
32. Body
33. Microphone

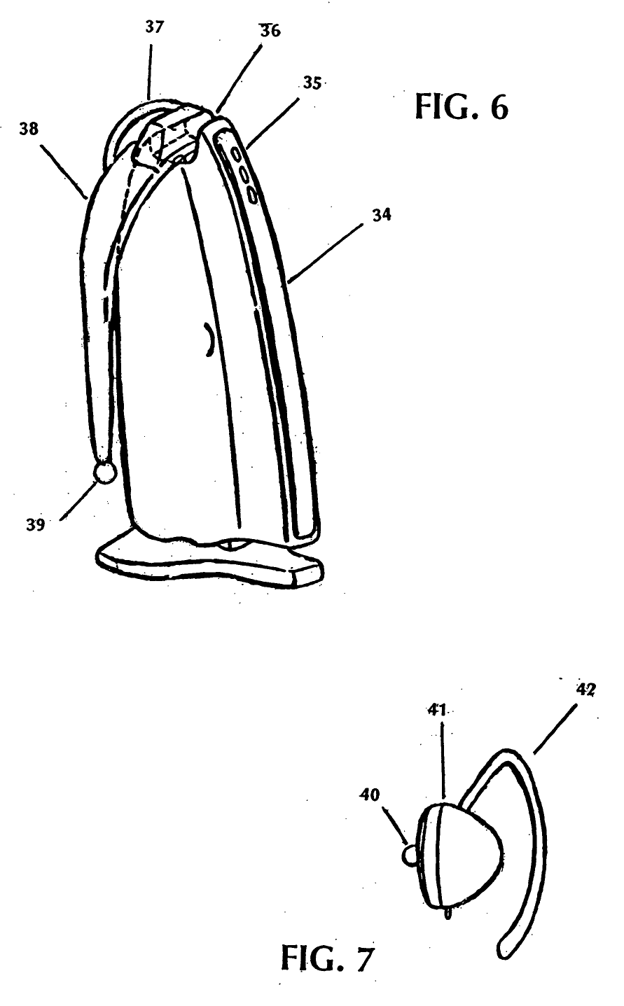

FIG. 6.
34. Body
35. LED 1,2,3
36. Headset charger armpit
37. Earhook engagement
38. Body of headset
39. Microphone

FIG. 7.
40. microphone
41. Body
42. Earhook engagement

### DETAILED DESCRIPTION

FIG. 1. a Voice Dependent Recognition Wireless Headset Universal Remote Control with Telecommunication Capabilities according to an embodiment of the present invention, a telecommunication transmitter and headset. A transmitted infrared light signal transmitted from the transmitter is received by the headset 2 which reproduce a responding signal to the entertainment unit. So if the telephone is to be heard, it will be heard by the listener through the headset. The headset is powered by a secondary battery (not shown) a rechargeable battery which may be recharged by a charging operation as will be described herein after.

The detailed description is the preferred specific implementation of a Voice Dependent Recognition Wireless Headset Universal Remote Control with Telecommunication Capabilities headset having two different components which serves both as Telecommunication equipment and Universal remote control equipment. However, the Telecommunication equipment and Universal remote control includes a component that appears neither in cordless telephone nor in universal remote controls that component is the mode controller (not shown). Mode controller is not part of the Telecommunication equipment or the Universal remote control. Instead, mode controller is a programmable bridge that functionally connects Telecommunication equipment and Universal remote control in such a way as to provide for enhanced user convenience. The headset is a battery powered device that is located in the headset. The primary functions of the preferred headset unit are to capture a good voice signal from the user, and also relay infrared (IR) commands to one or more entertainment systems and base unit. It contains a microphone 4, amplification and filtering circuitry 5, and three radio frequency (RF) transmitter 2. It also has an IR receiver and transmitter as so the base unit collectively called the (IR repeater).

Also shown in FIG. 1. the headset is generally comprised of a earhook engagement 1, a headphone unit portion 2, a microphone 4, which are supported by the earhook support engagement 3, which balance the entire body 5, respectively. The headset LED unit portion 2 also incorporates a speaker therein (not shown) and the earlobe supporter 3.

FIG. 2. is provided with RF receiving portion 6, train button 7, program button 8, base (stand) 9, charger in the central middle of the base unit armpit portion 12, body 10-11, covered with circuitry such as the speech recognition unit, IR receiver/transmitter pair, noise cancellation circuitry, signal generator, mode controller, amplifier circuit, and filter cap, respectively, which in a preferred embodiment are pervious only to infrared signals the RF receiving portion 6 inturn includes a light receiving surfaces on the back of the headphone unit portion 2 middle of body 5 and above the microphone 4, which is directed toward the entertainment devices in any direction the user is position. For example if the user is walking toward another room, the back of the headset unit 2 will transmit signal. If a user is lying down looking up toward the ceiling the middle body 5 and above microphone 4 LED units will transmit signal, if the user back is to the entertainment device the headset unit 2 will transmit signal. the LED positioning is set so as to receive a transmitted light signal supplied from any direction and is capable of transmitting that signal back out to the entertainment device and base unit and retrieve signals in return through the RF receiving portion 6, headset unit portion 2, respectively. The second unit is the base unit connected to the phone jack and DC outlet (not shown) in the room. The said unit must conveniently be placed in a place that can respond to headset and entertainment devices. Said unit contain a noise cancellation circuitry as well as the headset unit, signal generator, RF receiver, a speech recognition unit, and an IR receiver/transmitter pair in both the base and headset unit. The base unit has Telecommunication equipment transmitting systems for the headset wireless receiving capabilities because the circuitry requires significantly changing the basic operating features described herein. There are five modes, known as convenience modes that optimize the convenience for the user by reducing the extent to which Telecommunication equipment might interfere with utilization of entertainment devices and/or the extent to the entertainment devices might interfere with utilization of the Telecommunication equipment.

The five convenience modes are known as auto mute mode, auto pause mode, auto volume mode, auto caller ID, auto time display mode. In auto pause, auto volume, auto mute modes the user of entertainment devices is automatically and dynamically limited to facilitate utilization of Telecommunication equipment. The user may program the mode to be active by voice command. By voice commanding one of the above modes causes mode controller to activate the corresponding convenience mode and to respond to changing conditions accordingly.

The headset system is constructed as described above enables reception of the transmitted light signal even when the user turns his or her head in any direction, said unit receive the transmitted signal. The headset utilizes a secondary battery for supplying the drive power to the headset as described above. The secondary battery is held within the headset of FIG. 1., a rechargeable battery terminal portion is provided at the central middle of the earhook engagement when engaged with base unit terminal 12 of FIG. 2. the said unit is set to recharge the secondary battery.

More specificantly, disposed electronic circuits 10-11, which may include an amplifying circuit are incorporated in the filter cap (not shown). A circuit board is located within the body of base unit 10 of FIG. 2. on the lower side surface of the circuit board 10-11 (not shown) are formed charging terminals 12, which are adapted to function as input terminals for secondary battery. Holes are formed in the under wall of the headset portion 2 of FIG. 1. at the central portion and are positioned to be in line with terminal 12, respectively.

Upon charging the middle central portion of the headset portion 2 of FIG. 1. the said unit is placed in the recess concavity portion 12 of the base unit body 10-11 where upon the charge terminal 12 of the transmitter body are inserted through the through holes within the headset unit properly seated into the base unit. Enabling a charging current to be supplied from the supply terminals through the charging terminal 12 to the secondary battery in said unit. An opening and closing plate number is provided in charging terminal portion 12 and the through holes of headset and is adapted to open and close so as to uncover and cover, respectively. Therefore, a headset, three light receiving portions 6 are provided in the middle central portion of body 10-11, and on respective headset unit portion 2 as described. As a result, even when one of the light receiving portions is hidden by the user hair, another light receiving portion is likely to be able to satisfactorily receive the transmitted light signal from the transmitter. Further, the light receiving portion 2 provided on the middle central portion of the earhook includes the light receiving element whose light receiving surfaces is directed in a rearward direction and the light receiving portions of the headset unit 2. included light receiving element whose light receiving surfaces are directed in the back and front direction so that a light signal transmitted from any direction may be received by at least one of the light receiving elements. Therefore, regardless of the direction in which a user head is, who is wearing the headset, is facing, a satisfactory receiving condition is always maintained. Furthermore, the second light receiving element provided in the middle of headset unit 2 (not shown) are arranged so that their light receiving surfaces are orientated along the middle front directions, thereby enabling headset of the present invention to receive the transmitted light signal from the transmitter even while the user of headset is lying down. The third light receiving element is positioned end front above the microphone 4 of the headset unit 2 (not shown) the arranged is so that the light receiving while the user is looking to the left or right the present invention will receive the transmitted light signal.

FIG. 1. furthermore illustrates preferred two unit arrangement as if entertainment having several entertainment systems, including a DVD, SAT, VCR, Stereo system, Tivo, Cable box, Telephone line, Surround Sound system, a user of the entertainment system may have multiple of remotes that have been pre supplied with the various entertainment systems the preferred headset embodiment is a Voice Dependent Recognition Wireless Headset Universal Remote Control with Telecommunication Capabilities that replaces all of the pre supplied remotes. In particular, the preferred embodiment follows the two unit format mentioned above and includes a base unit positioned near the entertainment system, the headset is detailed as having an antenna (the antenna will be within the headset unit not externally visible) one microphone, three infrared transmission window through the lower middle and end central portion of earhook, which will receive and send infrared commands intended for the carious entertainment systems. The base unit is preferably positioned to intercept electronic signals output by receiver. Basic operation of headset and base unit is illustrated as microphone circuitry, an antenna, base unit, voice dependent program, for entering programs set and record program functions, (mode command) audio mute, an IR repeater, and three LED units. The IR repeater receives voice recognition entries, which are transmitted via infrared to the base unit, and echoes infrared commands intended for the entertainment systems, which are generally at the base unit preferred embodiment. FIG. 2. basic layout of base unit train button 7, program button 8, base unit supporter 9, an internal antenna, a RF demodulator, a filtration module, a speech recognition module, an IR transceiver and DTMF telecommunication system. The filtration module receives a continuous radio transmission from the headset microphone, and it also receives a number of speaker inputs, each is put through an analog and digital conversion (A/D) and transformed by the application of the speaker specific transfer function. The audio mimic signal speaker inturn, is subtracted from information representing sound received at the microphone to there by generating a residual. Because the audio mimic signal represents TV and stereo sound at the summing junction, the residual will represent primarily speech of the user. The residual is input to the speech recognition module which processes the residual to detect user speech, to learn new user spoken command, and to associate a detection of a known spoken command with an IR command intended for one or more of the entertainment systems, these commands are stored in an IR code selection table for selective transmission using the IR transceiver. Significantly, the headset and the base unit, do not process all generated audio, only user speech is important. The microphone removes high and low audio frequencies sent via RF to the base unit and headset unit. The preferred embodiment is designed to accept speaker inputs from a 5.1 channel system. The preferred embodiment must be configured to learn spoken commands, to learn IR commands that are to be associated with each spoken command, audio learn speaker configuration within a given room so as to accurately mimic audio. Speech recognition triggers the headset and base unit to enter into configuration and learning modes. The purpose of the command learning mode is to enable the base unit to detect spoken commands and associate them with infrared commands for sending to the carious entertainment systems. The headset and base unit automatically enters into these modes for initial configuration.

Operation

Design of Headset Unit

The design of a preferred headset unit 2 is presented using FIG. 1. the headset unit is somewhat similar in appearance and size to conventional wireless headsets. The preferred headset unit also includes a microphone, a power circuitry (not shown), three LED units, and mini circuit board for voice recognition. Because the headset unit normally functions to transmit sound detected by the microphone to the base unit back to the headset, it is desirable to power down the headset when not in use to conserve power. The IR transmission window faces toward the entertainment systems, the design of the headset unit positions the microphone and the microphone arm inclined toward the user mouth. The headset unit uses a battery to generate a direct current (DC) power supply and is used to drive the microphone circuitry, IR repeater, and speech recognition circuitry. The microphone circuitry includes a microphone, a band pass filter which removes low and high frequency components the output is then provided to an RF modulator which transmit audio which has been received at the microphone through an internal antenna to the base unit. The IR repeater circuitry uses both an infrared detector and an infrared transmitter each having a buffer and driver circuitry. The IR detector includes a buffer which demodulates infrared into a digital code, which is then transferred using a micro controller to the buffer and driver for the IR transmitter. The IR circuitry will affectively repeat received IR commands to reflect them back towards a stereo rack or entertainment center enable the micro controller chip also includes a buffer electronics, which controls code command to the base unit using a device code which is hard wired into the headset unit. Furthermore, the headset will contain speech recognition system as well as the base unit for better control and wider IR and RF range pick up.

Design of Base Unit

The base unit is a rectangular shape, having a AC cord for plug in to an outlet, speaker signals, telephone system and IR transmission window for communication with the headset unit and for learning IR commands by way of voice recognition, and a telephone input jack. The base unit receives power via a plug from an electrical outlet, which is then input to a power supply to generate a supply voltage. The base unit also includes a backup battery which helps enable memory retention in the event of a power failure for such things as learned spoken and IR commands. The base unit also includes a set of five external speaker inputs to the base unit from a stereo receiver or home system via wireless speaker. The antenna is coupled to an RF demodulator, an amplifier, a band pass filter and an analog to digital (A/D) converter for production of a digital signal. The signal represents an electronic speaker sound and spoken command received within the 200 hertz to 4,000 hertz range via the headset unit. The digital signal is then input to a subtraction circuit which filters the digital signal by subtraction from it the radio mimic signal to reproduce a residual.

Speech recognition is performed using the residual by first determining whether the residual possibly represent speech and, if so, by comparing the residual between incoming speech and characteristic of a spoken command, the control microprocessor is pointed to another address in RAM that stores digital information for each IR command to be transmitted, including device code and these are written by the microprocessor into buffer and driver circuitry for an IR. This buffer and driver circuitry is effective to transmit IR codes once loaded the transmission is preferably governed by hardware. Similarly, when an IR command is received at an IR receiver from the headset unit. If the incoming IR command reflects a mode command form the headset unit then the microprocessor effects the selected command or mode as soon as practical. If the incoming command includes any other device code, the spoken command and will otherwise disregard the incoming IR command. The base unit includes a signal generator and amplifier which are selectively activated by the control microprocessor during the speaker learning mode in order to generate test signals. However, during the speaker learning mode, the signal generator is given control over the outputs. The signal generator utilizes a read only memory (ROM) to generate appropriate test signals and drive each audio channel, inturn, as a slave to the control microprocessor.

During operation, if a spoken command is recognized, the base unit sends the associated IR command via its IR transmitter to the headset unit, which inturn sends those commands back to the appropriate entertainment devices. This is the task of the headset unit IR repeater.

Learning of Spoken and Infrared Commands

Learning of speaker and room configuration is required upon initial power up when speaker parameters are not available from memory, and when the user select a speaker learning mode voice recognized on the base unit. The base unit control microprocessor is master over the operation and performs two tests for each audio channel one channel at a time, during this calibration there should be complete silence besides the test signals. See John G. Proakis, Masaed Sahehi, “Communication System Engineering”, Prentice Hall, Englewood Cliffs, N.J. 07632 ISBN 0-13-158932-6 and See Edward A Lee, David G. Messer Schimitt, “Digital Communication” Flower Academic Publishers, Boston 1994, ISBN 0-7923-9391-0.

Learning Spoken Command

During command learning, there must be complete silence in the room besides the spoken commands. There are many different speech processing devices and algorithms which are commercially available. Selection of a suitable speech processing device or algorithm is left to one skilled in electronics. It is expected that the preferred device will use a vocabulary which is on the order of a hundred words to recognized the speech, therefore the embodiment uses stochastic speech processing system that processes phonemes and proceeding from one phoneme to the next, matches detected phonemes against a table of stored codes and determine whether a spoken command represent a stored code. The user voice command the learn mode to enter the command learning mode the headset unit sends an IR signal using the base units device code, such that it is detected by the control microprocessor. After the proceeding through the process for learning a spoken command. The user is prompted to point the headset unit toward the desired entertainment system and user voice the appropriate command. The user may combine commands for a number of devices. Between the time that the user voice commands the learn and end mode, the control microprocessor will associate any received IR command, other then mode commands with a particular audio command. The base unit receives the IR sequence via its IR receiver and stores the corresponding bit stream in the local RAM for the control microprocessor.

Speech recognition module first monitors the residual to determine whether the residual represents a possible spoken command and it so, then proceeds to map the detected signal against a data base representing the learning commands because speech may décor at different rates, each spoken command is preferably represented as a sequence of speech characteristics and matching of the detected signal against a known command. During the learning process, the user repeats a command to be learned a number of times in order to establish a data base which is then used in aid probability analysis the learned pattern is stored along with the associated IR bit string in the local RAM of the central microprocessor. The number of different users will be fairly limited in most cases and a separate vocabulary for each user can easily be maintained.

Microphone

Embodiment uses multiple microphones within the headset all separated from each other by a suitable distance.

### SUMMARY, RAMIFICATIONS, AND SCOPE

In summary, the present invention relates to a cordless Voice Dependent Recognition Wireless Headset Universal Remote Control with Telecommunication Capabilities with a programmable mode controller that automatically limits utilization of Telecommunication equipment and Universal remote control to reduce interference and/or interruptions. The user may select from five modes, including some which automatically facilitate utilization of communication equipment and two which automatically prevent telecommunication equipment from interrupting or interfering with utilization of one or more entertainment devices. Technology other than infrared might be utilized to transmits remote control signals to the entertainment devices. Likewise, voice recognition could be utilized to obtain user input. Although, recharging is accomplished in the illustrative and power maintained, instead, through use of spare batteries that are recharged out side of the headset and used to replace a discharged battery in the headset as needed. In addition, numerous other changes could also be made.

Having described several implementations of the invention, it will be apparent that various alterations modifications and improvements will be readily occur to those skilled in the art of product engineering. Such alterations, modifications and improvements, throughout describe above, are none the less intended and implied to be within the spirit and scope of the invention. The foregoing discussion is intended to be illustrative only.

1. Voice Dependent Recognition Wireless Headset Universal Remote Control With Telecommunication Capabilities comprising;
A. A headset that includes communication equipment and universal remote control equipment; and.
B. A mode controller in communication with Voice Dependent Recognition Wireless Headset Universal Remote Control With Telecommunication Capabilities and Voice Dependent Recognition Wireless Headset Universal Remote Control With Telecommunication Capabilities universal remote control equipment, wherein Voice Dependent Recognition Wireless Headset Universal Remote Control With Telecommunication Capabilities mode control provides a plurality of operator-selectable convenience modes which are activities by voice dependent recognition system by the user, upon detection of an incoming call, automatically Voice Dependent Recognition Wireless Headset Universal Remote Control With Telecommunication Capabilities limits utilizations of entertainment devices.

2. A Voice Dependent Recognition Wireless Headset Universal Remote Control With Telecommunication Capabilities according to claim 1 wherein:
A. Telecommunication equipment provides cordless telephone functionality; and

3. Universal remote control equipment provides for remote control of one or more entertainment devices.

4. A Voice Dependent Recognition Wireless Headset Universal Remote Control with Telecommunication Capabilities according to claim 1. Wherein, said unit Voice Dependent Recognition Wireless Headset Universal Remote Control with Telecommunication Capabilities mode controller automatically limits utilization of said communication equipment by preventing said communication equipment from producing an audible indication of said incoming calls.
communication equipment by preventing said communication equipment from producing an audible indication of said incoming calls.

5. A Voice Dependent Recognition WirelessHeadset Universal Remote Control With Telecommunication Capabilities according to claim 1, wherein said mode controller automatically limits said utilization of one or more entertainment devices by automatically causing said universal remote control equipment to modify at least one setting of said one or more entertainment devices.

6. A Voice Dependent Recognition Wireless Headset Universal Remote Control With Telecommunication Capabilities according to claim 1, wherein said plurality of convenience modes comprise:
A. A auto mute mode, wherein said one or more entertainment devices is muted in response to detection of said incoming calls;
B. An on screen caller ID, wherein said telecommunication equipment is producing an indication as to who is calling; and
C. An auto volume adjuster, wherein at least one volume controls of said one or more entertainment devices are adjusted downward in response to detection of said incoming call.

7. A Voice Dependent Recognition Wireless Headset Universal Remote Control with Telecommunication Capabilities power voice command at least one channel changing voice command.

8. A method for automatically limiting concurrent utilization of telecommunication equipment and one or more entertainment devices, said method comprising;
A. Providing a headset that includes telecommunication equipment, universal remote control equipment and a mode controller in communication with control equipment, and a mode controller in communication with said telecommunication equipment and said universal remote control equipment, wherein said mode controller provides a plurality of user selectable convenience modes which are activated by a common user input mechanism.
B. Wherein a first convenience mode of said plurality of convenience modes corresponds to automatically limiting utilization if said communication equipment in response to detection of an incoming call;
C. Wherein a second convenience mode of said plurality of convenience modes corresponds to automatically limiting to utilization of said one or more entertainment devices in response to detection of an incoming call;

9. Receiving use in put through said common operator input mechanism activation an user selected on e of said mode controller;
A. detecting an incoming call at said mode controller;
B. Determine that the user selected convenience mode is active: and
C. In response of detection of said incoming call, automatically limiting utilization of at least one of said telecommunication equipment and said one or more entertainment devices, corresponding to said user selected active convenience mode.

10. Said step of accepting user input comprises accepting operator input activating on of said four or more convenience mode.

11. A Voice Dependent Recognition Wireless Headset Universal Remote Control with Telecommunication Capabilities that provides at least one convenience mode for a cordless telecommunication equipment and universal remote control equipment headset that includes telecommunication equipment and universal remote control equipment, said headset comprising;
A. A mode controller that provides at least one convenience mode such that when said mode controller is in communication with said telecommunication equipment and said universal remote control equipment and said at least one convenience mode is active, said mode controller in response to detection of an incoming call, automatically limits utilizations of at least one of said communication equipment and one or more entertainment devices, wherein communication equipment and one or more entertainment devices based on said active convenience mode, wherein;
B. said mode controller supports two or more convenience modes;
C. said two or more convenience mode;
D. said mode controller automatically limits said utilization in accordance with said activated convenience mode;
said telecommunication equipment and universal remote control equipment headset further comprise of at least one channel changing voice command and one power voice command.
